(19) United States
(12) Patent Application Publication
(10) Pub. No.: US 2026/0290021 A1
(43) Pub. Date: Sep. 24, 2026

(54) INFORMATION PROCESSING APPARATUS, INFORMATION PROCESSING METHOD, AND RECORDING MEDIUM

(71) Applicant: NEC Corporation, Tokyo (JP)

(72) Inventors: Hirokazu HAMADA, Tokyo (JP); Kensaku SATO, Tokyo (JP); Masalo KITADA, Tokyo (JP)

(73) Assignee: NEC Corporation, Tokyo (JP)

(21) Appl. No.: 19/475,147

(22) PCT Filed: Apr. 20, 2023
(86) PCT No.: PCT/JP2023/015788

§ 371 Date: Oct. 14, 2025

(51) Int. Cl. G06V 20/52; G06V 40/16; G07C 9/25; G07C 9/28

(52) U.S. Cl. CPC G06V 20/52; G06V 40/172; G07C 9/253; G07C 9/28; G07C 2209/14

(57) ABSTRACT

An information processing apparatus includes: an image acquisition unit that acquires an image including a facial recognition area, which is set before an entry restriction area in which a user of a special car requiring a special fee is permitted to enter, and through which the user passes; a facial recognition unit that performs facial recognition on an authentication subject who is the user, based on the image; and a determination unit that acquires ticket information about a ticket for the special car linked to a registrant corresponding to the authentication subject, who is identified by the facial recognition, and that determines whether or not the authentication subject is permitted to enter the entry restriction area.

### TECHNICAL FIELD

The present disclosure relates to technical fields of an information processing apparatus, an information processing method, and a recording medium.

### BACKGROUND ART

As this type of apparatus, for example, there is proposed an apparatus that acquires a first facial image of a user when ticket information is issued to the user of a railway, that acquires a second facial image of the user when the user passes through a ticket gate, that compares the first facial image and the second facial image, and that permits the user to pass through when the first and second facial images are match (see Patent Literature 1). Other prior art documents related to this disclosure include Patent Literatures 2 to 4.

### CITATION LIST

### Patent Literature

[Patent Literature 1] JP2012-079157A

[Patent Literature 2] International Publication No. WO2020/240801

[Patent Literature 3] International Publication No. WO 2021/059526

[Patent Literature 4] JP2019-114294A

### SUMMARY

### Technical Problem

It is an example object of the present disclosure to provide an information processing apparatus, an information processing method, and a recording medium that aim to improve the techniques/technologies disclosed in Citation List.

### Solution to Problem

An information processing apparatus according to an example aspect includes: an image acquisition unit that acquires an image including a facial recognition area, which is set before an entry restriction area in which a user of a special car requiring a special fee is permitted to enter, and through which the user passes; a facial recognition unit that performs facial recognition on an authentication subject who is the user, based on the image; and a determination unit that acquires ticket information about a ticket for the special car linked to a registrant corresponding to the authentication subject, who is identified by the facial recognition, and that determines whether or not the authentication subject is permitted to enter the entry restriction area.

An information processing method according to an example aspect includes: acquiring an image including a facial recognition area, which is set before an entry restriction area in which a user of a special car requiring a special fee is permitted to enter, and through which the user passes; performing facial recognition on an authentication subject, based on the image; and acquiring ticket information about a ticket for the special car linked to a registrant corresponding to the authentication subject, who is identified by the facial recognition, and determining whether or not the authentication subject is permitted to enter the entry restriction area.

A recording medium according to an example aspect is a recording medium on which a computer program that allows a computer to execute an information processing method is recorded, the information processing method including: acquiring an image including a facial recognition area, which is set before an entry restriction area in which a user of a special car requiring a special fee is permitted to enter, and through which the user passes; performing facial recognition on an authentication subject, based on the image; and acquiring ticket information about a ticket for the special car linked to a registrant corresponding to the authentication subject, who is identified by the facial recognition, and determining whether or not the authentication subject is permitted to enter the entry restriction area.

### BRIEF DESCRIPTION OF DRAWINGS

FIG. 1 is a diagram illustrating an example of a ticket gate system.

FIG. 2 is a diagram illustrating an example of a facial information database.

FIG. 3 is a block diagram illustrating a configuration of an information processing apparatus.

FIG. 4 is a diagram illustrating an example of a facial recognition area.

FIG. 5 is a flowchart illustrating operation of an information processing apparatus according to a first example embodiment.

FIG. 6 is a diagram illustrating another example of the facial recognition area.

FIG. 7 is a diagram illustrating another example of the facial recognition area.

FIG. 8 is a block diagram illustrating another configuration of the information processing apparatus.

FIG. 9 is a diagram for explaining tracking processing of tracking a person.

FIG. 10 is a diagram illustrating an example of an ID correspondence table.

FIG. 11 is a diagram illustrating another example of the facial recognition area.

### DESCRIPTION OF EXAMPLE EMBODIMENTS

### First Example Embodiment

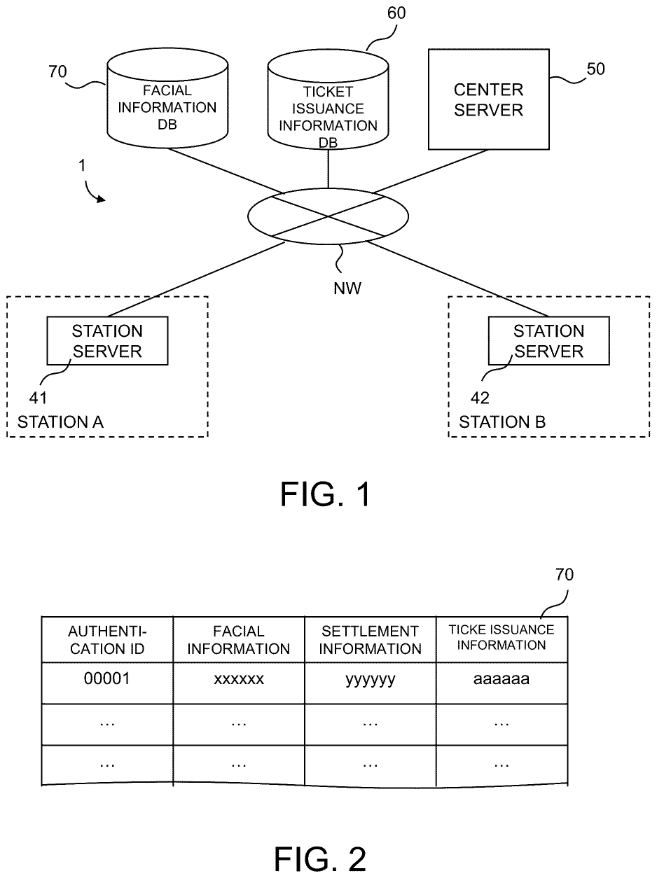

An information processing apparatus, an information processing method, and a recording medium according to a first example embodiment will be described with reference to FIG. 1 to FIG. 5. The following describes the information processing apparatus, the information processing method, and the recording medium according to the first example embodiment, by using an information processing apparatus 10 provided in a ticket gate system 1.

### (overview of Ticket Gate System)

An overview of a ticket gate system according to the first example embodiment will be described with reference to FIG. 1. In FIG. 1, the ticket gate system 1 includes: a station server 41 installed at a station A, which is a railway station; a station server 42 installed at a station B, which is a railway station; a center server 50; a ticket issuance information database 60; and a facial information database 70. The ticket issuance information database 60 will be hereinafter referred to as a “ticket issuance information DB 60” as appropriate. The facial information database 70 will be hereinafter referred to as a “facial information DB 70” as appropriate.

The station servers 41 and 42, the center server 50, the ticket issuance information DB 60, and the facial information DB 70 are connected via a network NW. The network NW is, for example, a wide area network such as the Internet.

The station server 41 may acquire information indicating that a railway user has entered the station A. For example, in a case where a ticket gate apparatus (e.g., an automatic ticket gate) for which at least one of an IC (Integrated Circuit) ticket and a mobile ticket is usable, is installed at the station A, the station server 41 may acquire, from the ticket gate apparatus, information indicating that a user holding an IC ticket or mobile ticket has entered the station A. In this case, the station server 41 may link identification information about the IC ticket or mobile ticket, with the information indicating that the user has entered the station A, and may transmit the linked information to the center server 50. In a case where an authentication apparatus that detects the user's entry/exit by using biometric authentication (e.g., facial recognition, iris recognition, etc.) is installed at the station A, the station server 41 may acquire, from the authentication apparatus, information indicating that a user (in other words, an authentication subject) has entered the station A. In this case, the station server 41 may link identification information about the user, with the information indicating that the user has entered the station A, and may transmit the linked information to the center server 50.

The station server 41 may acquire information indicating that a railway user has exited from the station A. For example, in a case where a ticket gate apparatus for which at least one of an IC ticket and a mobile ticket is usable, is installed at the station A, the station server 41 may acquire, from the ticket gate apparatus, information indicating that a user holding an IC ticket or mobile ticket has exited from the station A. In this case, the station server 41 may link identification information about the IC ticket or mobile ticket, with the information indicating that the user has exited from the station A, and may transmit the linked information to the center server 50. In a case where an authentication apparatus that detects the user's entry/exit by using biometric authentication is installed at the station A, the station server 41 may acquire, from the authentication apparatus, information indicating that a user (in other words, an authentication subject) has exited from the station A. In this case, the station server 41 may link identification information about the user, with the information indicating that the user has exited from the station A, and may transmit the linked information to the center server 50.

The station server 42 may acquire information indicating that a railway user has entered the station B. For example, in a case where a ticket gate apparatus for which at least one of an IC ticket and a mobile ticket is usable, is installed at the station B, the station server 42 may acquire, from the ticket gate apparatus, information indicating that a user holding an IC ticket or mobile ticket has entered the station B. In this case, the station server 42 may link identification information about the IC ticket or mobile ticket, with the information indicating that the user has entered the station B, and may transmit the linked information to the center server 50. In a case where an authentication apparatus that detects the user's entry/exit by using biometric authentication is installed at the station B, the station server 42 may acquire, from the authentication apparatus, information indicating that a user (in other words, an authentication subject) has entered the station B. In this case, the station server 42 may link identification information about the user, with the information indicating that the user has entered the station B, and may transmit the linked information to the center server 50.

The station server 42 may acquire information indicating that a railway user has exited from the station B. For example, in a case where a ticket gate apparatus for which at least one of an IC ticket and a mobile ticket is usable, is installed at the station B, the station server 42 may acquire, from the ticket gate apparatus, information indicating that a user holding an IC ticket or mobile ticket has exited from the station B. In this case, the station server 42 may link identification information about the IC ticket or mobile ticket, with the information indicating that the user has exited from the station B, and may transmit the linked information to the center server 50. In a case where an authentication apparatus that detects the user's entry/exit by using biometric authentication is installed at the station B, the station server 42 may acquire, from the authentication apparatus, information indicating that a user (in other words, an authentication subject) has exited from the station B. In this case, the station server 42 may link identification information about the user, with the information indicating that the user has exited from the station B, and may transmit the linked information to the center server 50.

For example, let us assume that one user enters the station A, travels by train from the station A to the station B, and exits from the station B. In this case, the center server 50 may register the one user's entry to the station A and exit from the station B. The center server 50 may calculate railway charges (e.g., fares) from the station A to the station B. The center server 50 may settle the calculated railway charges by using settlement/payment information about the one user. The settlement information may be, for example, at least one of credit card information, debit card information, prepaid card information, IC card information, and account information.

The ticket issuance information DB 60 registers/stores ticket issuance information about a ticket (e.g., a limited express train ticket, a green car ticket, a reserved seat ticket, etc.) for using a special car requiring a special fee. The “special fee” means a fee to be paid separately from the fares in order to use a special car. The “special car” means a car requiring a special fee for using the car. Furthermore, all cars in a train formation may be special cars, or only a part of the cars in a formation may be a special car(s). An example of a train in which all cars in a formation are special cars, may be, for example, a limited express train, Shinkansen or bullet train, or the like. An example of a train in which only a part of the cars in a formation is a special car(s), may be, for example, a train including both ordinary cars (i.e., cars that may be boarded by paying a basic fare only) and green cars. In the following description, for convenience, the “ticket for using a special car” will be referred to as an “limited express train ticket.”

For example, in a case where a limited express train ticket vending machine is installed at the station A, the station server 41 may display vacant seat information on a screen of the ticket vending machine with reference to the ticket issuance information DB 60. In a case where a limited express train ticket is issued by the ticket vending machine, the station server 41 may acquire information about the ticket issued from the vending machine (e.g., train name, seat number, settlement information, etc.). The station server 41 may transmit the acquired information about the limited express train ticket to the center server 50. The center server 50 may update registration content of the ticket issuance information DB 60, based on the information about the limited express train ticket transmitted from the station server 41.

For example, in a case where a limited express train ticket vending machine is installed at the station B, the station server 42 may display vacant seat information on a screen of the ticket vending machine with reference to the ticket issuance information DB 60. In a case where a limited express train ticket is issued by the ticket vending machine, the station server 42 may acquire information about the ticket issued from the vending machine. The station server 42 may transmit the acquired information about the limited express train ticket to the center server 50. The center server 50 may update registration content of the ticket issuance information DB 60, based on the information about the limited express train ticket transmitted from the station server 42.

The facial information DB 70 registers/stores information about those wishing to use the ticket gate system 1. Among those wishing to use the ticket gate system 1, a person whose information is registered in the facial information DB 70 is referred to as a “registrant” as appropriate. The facial information DB 70 registers/stores authentication IDs serving as identification information for respectively identifying/distinguishing a plurality of registrants. Information about each of the plurality of registrants is linked to the corresponding authentication ID and is registered in the facial information DB 70.

Here, the facial information DB 70 will be described with reference to FIG. 2. As illustrated in FIG. 2, facial information, settlement information, and ticket issuance information may be linked to the authentication ID of a single registrant. The facial information may be, for example, feature quantities themselves indicating facial features of the single registrant, or information (e.g., a file name) for identifying the feature quantities. Alternatively, the facial information may be, for example, a facial image itself including a face of the single registrant, or information (e.g., a file name) for identifying the facial image. The ticket issuance information may be information about a limited express train ticket. That is, the ticket issuance information corresponds to the ticket issuance information registered in the ticket issuance information DB 60.

For example, in a case where a ticket vending machine is installed at the station A and a limited express train ticket is issued by the ticket vending machine, the station server 41 may acquire information about the limited express train ticket issued by the ticket vending machine (e.g., train name, seat number, settlement information, etc.). The station server 41 may transmit the acquired information about the limited express train ticket to the center server 50. The center server 50 may identify a registrant having purchased the limited express train ticket, based on the settlement information included in the information about the limited express train ticket transmitted from the station server 41 and the settlement information registered in the facial information DB 70. The center server 50 may link the ticket issuance information to the authentication ID of the identified registrant, based on the information about the limited express train ticket transmitted from the station server 41 (i.e., may register the ticket issuance information in the facial information DB 70).

For example, in a case where a ticket vending machine is installed at the station B and a limited express train ticket is issued by the ticket vending machine, the station server 42 may acquire information about the limited express train ticket issued by the ticket vending machine (e.g., train name, seat number, settlement information, etc.). The station server 42 may transmit the acquired information about the limited express train ticket to the center server 50. The center server 50 may identify a registrant having purchased the limited express train ticket, based on the settlement information included in the information about the limited express train ticket transmitted from the station server 42 and the settlement information registered in the facial information DB 70. The center server 50 may link the ticket issuance information to the authentication ID of the identified registrant, based on the information about the limited express train ticket transmitted from the station server 42 (i.e., may register the ticket issuance information in the facial information DB 70).

### Information Processing Apparatus

The ticket gate system 1 may include, for example, an information processing apparatus 10 installed at the station A. The information processing apparatus 10 may be connected to the station server 41 via a narrow area network such as, for example, a local area network (LAN). Note that an information processing apparatus similar to the information processing apparatus 10 may also be installed at the station B, for example.

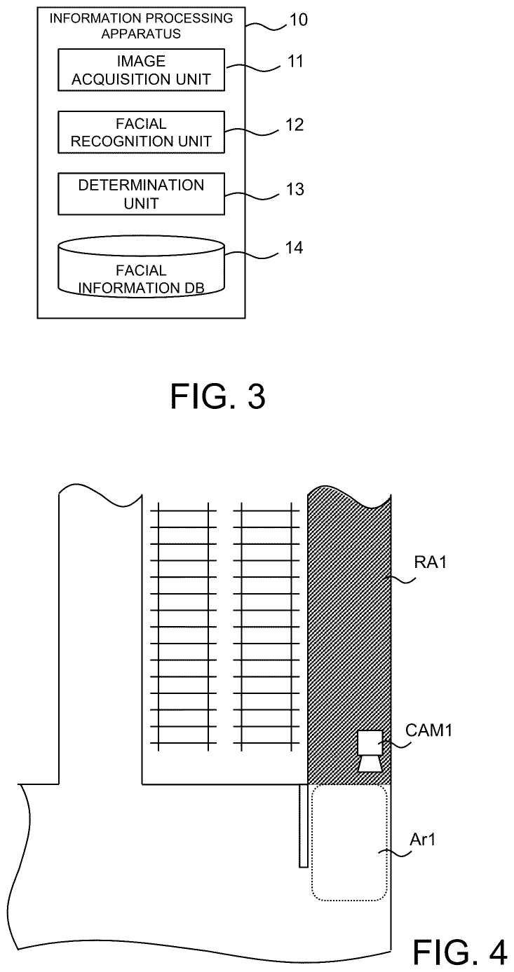

In FIG. 3, the information processing apparatus 10 includes an image acquisition unit 11, a facial recognition unit 12, an information processing unit 13, and a facial information database 14 (hereinafter referred to as a “facial information DB 14” as appropriate). Incidentally, the facial information DB 14 may register/store the same information as that registered in the facial information DB 70. The facial information DB 14 may be updated at predetermined intervals to ensure that the information registered in the facial information DB 14 is the same as that that registered in the facial information DB 70.

Here, let us assume that the station A is a stop for a special train including special cars requiring a special fee (in other words, requiring a limited express train ticket for boarding). At the station A, a dedicated platform is used for boarding and alighting from a special train. At the station A, only those holding limited express train tickets (i.e., tickets for boarding a special train) enter the dedicated platform. Therefore, the dedicated platform may be referred to as an entry restriction area.

The station A will be described with reference to FIG. 4. In FIG. 4, a hatched area is a entry restriction area RA corresponding to the dedicated platform. Inside the ticket gates of the station A (hereinafter referred to as “premises” as appropriate), a facial recognition area Ar1 for users (in other words, passengers) of a special train to pass through is set before the entry restriction area RAI. Note that the facial recognition area Ar1 is a virtual area. Therefore, for example, any markings or the like indicating the facial recognition area Ar1 may not be drawn in the premises of the station A. However, markings or the like indicating the facial recognition area Ar1 may be drawn in the premises of the station A. In FIG. 4, an end of the facial recognition area Ar1 on a side of the entry restriction area RAI is set to be in contact with a part of an outer edge of the entry restriction area RA1. Note that the end of the facial recognition area Ar1 on the entry restriction area RAI side may also be set not to be in contact with the outer edge of the entry restriction area RA1.

A camera CAMI is installed to capture images of the facial recognition area Ar. The camera CAMI may not be installed such that the entire facial recognition area Ar1 is included within its angle of view. In other words, the camera CAMI may be installed to capture images of at least a part of the facial recognition area Ar1. The camera CAMI may be installed at a position that does not obstruct the passage of the users of a special train (e.g., at a position higher than the users' heads).

The camera CAMI may be a high-resolution camera, such as a 4K resolution camera. The camera CAMI may be connected to the information processing apparatus 10 via a cable or by using a wireless communication technology. Alternatively, the camera CAMI may be connected to the station server 41 via a cable or by using the wireless communication technology. The station A may be additionally provided with another camera that is configured to capture images of at least a part of the facial recognition area Ar1, in addition to the camera CAMI. That is, the station A may be provided with two or more cameras that are configured to capture images of the facial recognition area Ar1.

Returning to FIG. 3, the image acquisition unit 11 of the information processing apparatus 10 acquires an image including the facial recognition area Ar1, which is generated by the camera CAMI capturing the facial recognition area Ar1. The image acquisition unit 11 may acquire the image directly from the camera CAMI or may acquire it from the camera CAMI via the station server 41.

The facial recognition unit 12 performs facial recognition, based on the image acquired by the image acquisition unit 11. Note that various existing aspects, such as a two-dimensional (2D) authentication method or three-dimensional (3D) authentication method, may be applicable to the facial recognition. An example of processing related to the facial recognition will be described below.

The facial recognition unit 12 may detect a face of a user included in the image (hereinafter referred to as an “authentication subject”). The facial recognition unit 12 may calculate facial feature quantities indicating the features of the detected face. The facial recognition unit 12 may identify a registrant corresponding to the authentication subject, by using the calculated facial feature quantities and the facial information DB 14.

The facial recognition unit 12 may calculate a matching score from the calculated facial feature quantities (i.e., facial feature quantities related to the face of the authentication subject) and from facial feature quantities based on the facial information on a single registrant registered in the facial information DB 14. In a case where the calculated matching score exceeds a predetermined threshold, the facial recognition unit 12 may determine that the single registrant is a registrant corresponding to the authentication subject.

In a case where the calculated matching score is less than the predetermined threshold, the facial recognition unit 12 may calculate a matching score from the calculated facial feature quantities and from facial feature quantities based on the facial information on another registrant registered in the facial information DB 14. In this case, the facial recognition unit 12 may determine that the single registrant is not the registrant corresponding to the authentication subject. In a case where the calculated matching score is “equal” to the predetermined threshold, it may be included in one of the cases.

The determination unit 13 may acquire, from the facial information DB 14, the ticket issuance information that is linked to the authentication ID of the registrant identified by the facial recognition unit 12. In a case where the ticket issuance information is not linked to the authentication ID (i.e., in a case where the registrant associated with the authentication ID does not purchase a limited express train ticket), the determination unit 13 may acquire, for example, information indicating that “the authentication subject does not have a valid limited express train ticket” as the ticket issuance information. The ticket issuance information is information about a ticket for using a special car (e.g., a limited express train ticket), i.e., a ticket for boarding a special car. Therefore, the ticket issuance information may also be referred to as ticket information.

The determination unit 13 determines, based on the acquired ticket issuance information, whether or not the registrant identified by the facial recognition unit 12 (in other words, the authentication subject) is permitted to enter the entry restriction area RA1. For example, in a case where the ticket issuance information indicates information about a valid limited express train ticket, the determination unit 12 may determine that the aforementioned registrant is permitted to enter the entry restriction area RA1. Here, the “valid limited express train ticket” may mean a limited express train ticket for a special train departing from the station A after a current time.

For example, in a case where the ticket issuance information indicates information about an invalid limited express train ticket, the determination unit 12 may determine that the aforementioned registrant is not permitted to enter the entry restriction area RA1. Here, the “invalid limited express train ticket” may mean a limited express train ticket for a special train departing from the station A before the current time. The “information about the invalid limited express train ticket” may include information about a limited express train ticket for a special train departing from the station A before the current time, and information indicating that the ticket issuance information is not linked to the authentication ID in the facial information DB 14 (e.g., information indicating that “the authentication subject does not have a valid limited express train ticket”).

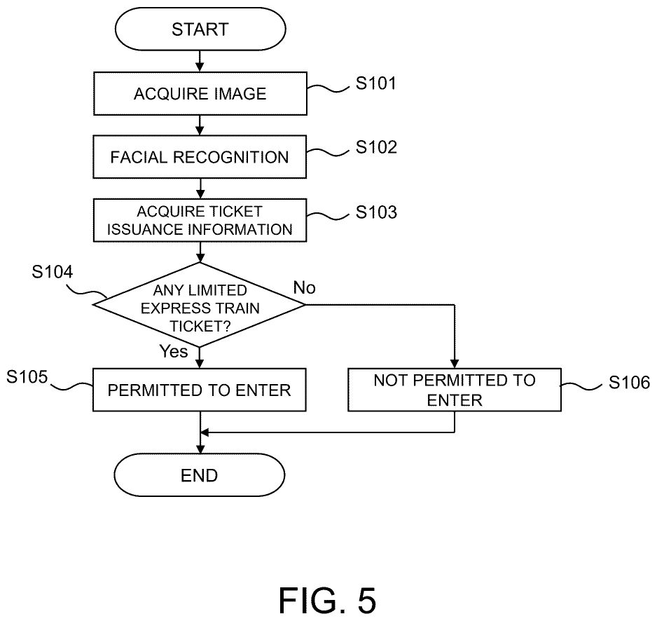

Next, with reference to a flowchart in FIG. 5, the operation of the information processing apparatus 10 will be described. In FIG. 5, the image acquisition unit 11 acquires the image including the facial recognition area Ar1 (step S101). The facial recognition unit 12 performs the facial recognition based on the image acquired in the step S101 (step S102).

The determination unit 13 acquires the ticket issuance information linked to the authentication ID of the registrant identified in the step S102 (step S103). The determination unit 13 determines whether or not the identified registrant is permitted to enter the entry restriction area RAI, based on the ticket issuance information acquired in the step S103. For example, the determination unit 13 may determine whether or not the identified registrant has a valid limited express train ticket (step S104).

In a case where it is determined in the step S104 that the identified registrant has a valid limited express train ticket (in other words, the ticket issuance information indicates the information about a valid limited express train ticket) (step S104: Yes), the determination unit 13 determines that the identified registrant is permitted to enter the entry restriction area RAI (step S105).

In a case where it is determined in the step S104 that the identified registrant does not have a valid limited express train ticket (i.e., the ticket issuance information indicates the information about an invalid limited express train ticket) (step S104: No), the determination unit 13 determines that the identified registrant is not permitted to enter the entry restriction area RA1 (step S106). A station staff at the station A may be notified of a determination result of the determination unit 13, for example.

As described above, performed in the information processing apparatus 10 is an information processing method including: acquiring an image including a facial recognition area, which is set before an entry restriction area in which a user of a special car requiring a special fee is permitted to enter and through which the user passes; performing facial recognition on an authentication subject, based on the image; and acquiring ticket information about a ticket for the special car linked to a registrant corresponding to the authentication subject, who is identified by the facial recognition, and determining whether or not the authentication subject is permitted to enter the entry restriction area.

The aforementioned information processing apparatus 10 may be realized by a computer reading a computer program recorded on a recording medium. In this case, it can be said that a computer program that allows a computer to execute an information processing method is recorded on a recording medium, the information processing method including: acquiring an image including a facial recognition area, which is set before an entry restriction area in which a user of a special car requiring a special fee is permitted to enter and through which the user passes; performing facial recognition on an authentication subject, based on the image; and acquiring ticket information about a ticket for the special car linked to a registrant corresponding to the authentication subject, who is identified by the facial recognition, and determining whether or not the authentication subject is permitted to enter the entry restriction area.

### Technical Effect

The information processing apparatus 10 is configured to identify a railway station user who is permitted to enter the entry restriction area RAI (i.e., the platform for boarding and alighting from a special train). This prevents a railway station user having no limited express train ticket from accidentally or intentionally boarding a special train. Therefore, according to the information processing apparatus 10, it is possible to appropriately collect the special fee from the users of a special train.

### Modified Example

A facial recognition area (e.g., the facial recognition area Ar1) may be appropriately configured depending on the structure of a railway station (e.g., the station A).

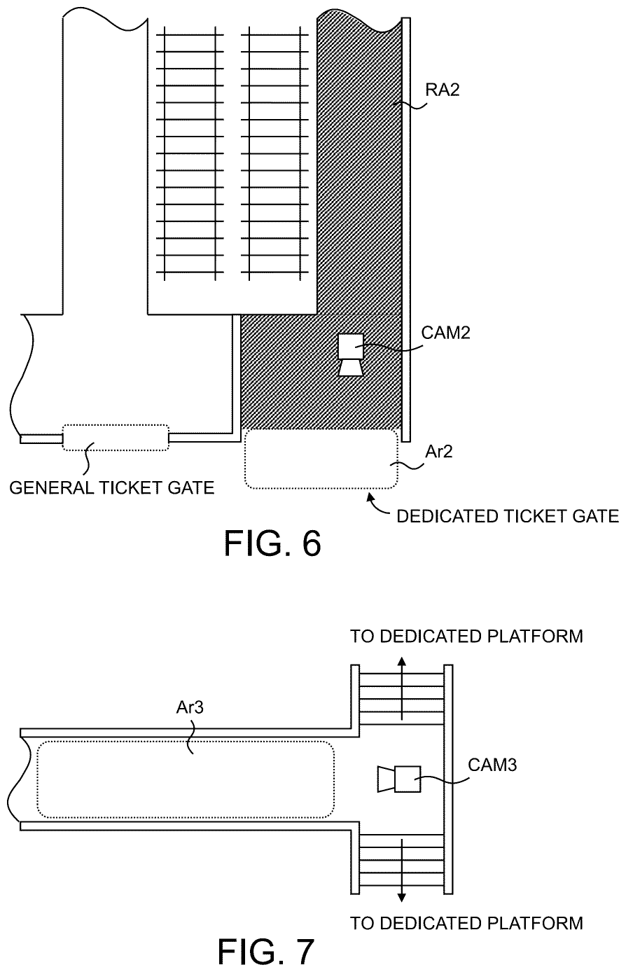

For example, at a railway station, a ticket gate for passage of users of a local train (i.e., a train that may be boarded by paying a basic fare only) (e.g., “General Ticket Gate” in FIG. 6) and a ticket gate for passenger of users of a special train (i.e., a train requiring a limited express train ticket for boarding) (e.g., “Dedicated Ticket Gate” in FIG. 6) may be provided at different positions. In this case, an area inside the ticket gate for the users of a special train to pass through at the railway station may be an entry restriction area (e.g., a “entry restriction area RA2” in FIG. 6). In this case, as illustrated in FIG. 6, a facial recognition area Ar2 may be set in an area corresponding to the ticket gate for the users of a special train to pass through.

In FIG. 6, a camera CAM2 is installed to capture images of the facial recognition area Ar2. The camera CAM2 may not be installed such that the entire facial recognition area Ar2 is included within its angle of view. In other words, the camera CAM2 may be installed to capture images of at least a part of the facial recognition area Ar2. The camera CAM2 may be installed at a position that does not obstruct the passage of the users of a special train (e.g., at a position higher than the users' heads).

In this case, the image acquisition unit 11 of the information processing apparatus 10 may acquire an image including the facial recognition area Ar2. In a case where the authentication subject (in other words, the registrant identified by the facial recognition unit 12) is determined to be permitted to enter the entry restriction area RA2, the determination unit 13 may determine that the authentication subject has entered the railway station (e.g., the station A). The information processing apparatus 10 may transmit information indicating that the authentication subject has entered the railway station, to a station server (e.g., the station server 41). That is, the information processing apparatus 10 may detect that the authentication subject has entered the railway station, in addition to determining whether or not the authentication subject is permitted to enter the entry restriction area RA2.

For example, as illustrated in FIG. 7, a facial recognition area Ar3 may be set in at least a part of a passageway leading to the dedicated platform used for boarding and alighting from a special train. The “passageway leading to the dedicated platform used for boarding and alighting from a special train” is not limited to “a path for moving to the dedicated platform used for boarding and alighting from a special train,” but may also conceptually include “spaces (e.g., concourse, floors, etc.) to pass through when moving to the dedicated platform used for boarding and alighting from a special train.” In FIG. 7, the facial recognition area Ar3 is set on a flat section of the passageway, but the facial recognition area may also be set on an inclined section of the passageway (e.g., stairs, escalators, etc.).

In FIG. 7, a camera CAM3 is installed to capture images of the facial recognition area Ar3. The camera CAM3 may not be installed such that the entire facial recognition area Ar3 is included within its angle of view. In other words, the camera CAM3 may be installed to capture images of at least a part of the facial recognition area Ar3. The camera CAM3 may be installed at a position that does not obstruct the passage of the users of a special train (e.g., at a position higher than the users' heads).

### Second Example Embodiment

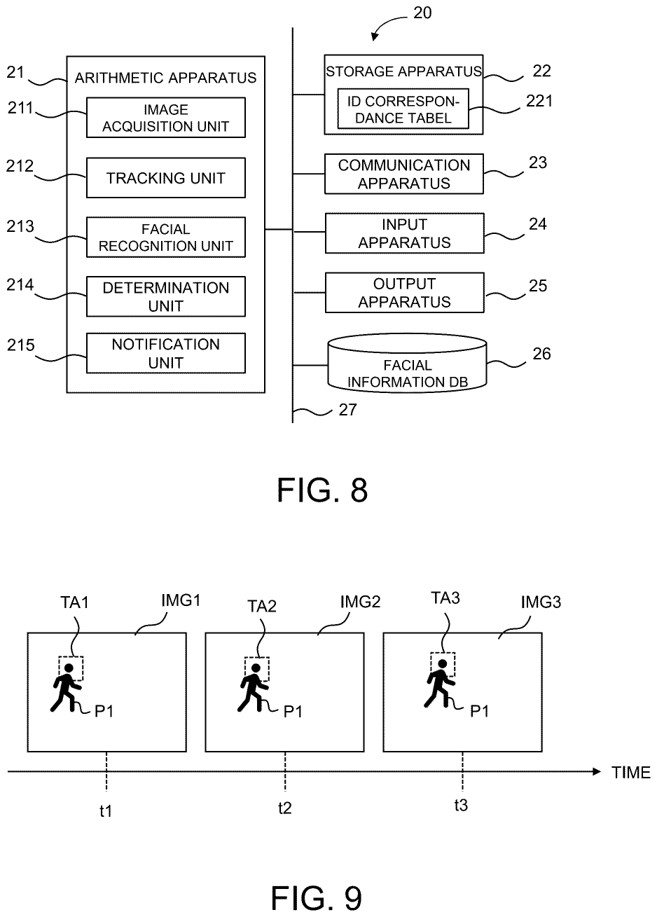

An information processing apparatus, an information processing method, and a recording medium according to a second example embodiment will be described with reference to FIG. 8 to FIG. 10. The following describes the information processing apparatus, the information processing method, and the recording medium according to the second example embodiment, by using an information processing apparatus 20. In the second example embodiment, a description that overlaps with that of the first example embodiment is omitted as appropriate.

In the second example embodiment, the ticket gate system 1 illustrated in FIG. 1 may include, for example, the information processing apparatus 20 installed at the station A. The information processing apparatus 20 may be connected to the station server 41 via a narrow area network such as, for example, a LAN. Note that an information processing apparatus similar to the information processing apparatus 20 may also be installed at the station B, for example.

Let us assume that the station A is a stop for a special train including special cars requiring a special fee (in other words, requiring a limited express train ticket for boarding). At the station A, a dedicated platform is used for boarding and alighting from a special train. At the station A, only those holding limited express train tickets (i.e., tickets for boarding a special train) enter the dedicated platform. Therefore, the dedicated platform may be referred to as an entry restriction area.

In FIG. 4, a hatched area is the entry restriction area RA corresponding to the dedicated platform. Inside the ticket gates of the station A (hereinafter referred to as “premises” as appropriate), the facial recognition area Ar1 for users (in other words, passengers) of a special train to pass through is set before the entry restriction area RA1. The camera CAMI is installed to capture images of the facial recognition area Ar1.

### Configuration of Information Processing Apparatus

In FIG. 8, the information processing apparatus 20 includes an arithmetic apparatus 21, a storage apparatus 22, and a communication apparatus 23. The information processing apparatus 20 may further include an input apparatus 24 and an output apparatus 25. The information processing apparatus 20 may include a facial information database 26 (hereinafter referred to as a “facial information DB 26” as appropriate). The information processing apparatus 20 may not include at least one of the input apparatus 24 and the output apparatus 25. In the information processing apparatus 20, the arithmetic apparatus 21, the storage apparatus 22, the communication apparatus 23, the input apparatus 24, the output apparatus 25, and the facial information DB 26 may be connected via a data bus 27.

Incidentally, the facial information DB 26 may register/store the same information as that registered in the facial information DB 70. The facial information DB 26 may be updated at predetermined intervals to ensure that the information registered in the facial information DB 26 is the same as that registered in the facial information DB 70.

The arithmetic apparatus 21 may include, for example, at least one of a CPU (Central Processing Unit), a GPU (Graphics Processing Unit), an FPGA (Field Programmable Gate Array), a TPU (Tensor Processing Unit), and a quantum processor.

The storage apparatus 22 may include, for example, at least one of a RAM (Random Access Memory), a ROM (Read-Only Memory), a hard disk apparatus, a magneto-optical disk apparatus, an SSD (Solid State Drive), and an optical disk array. That is, the storage apparatus 22 may include a non-transitory recording medium. The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program.

The communication apparatus 23 may be configured to communicate with an apparatus external to the information processing apparatus 20. The communication apparatus 23 may perform wired communication or wireless communication.

The input apparatus 24 is an apparatus that is configured to receive an input of information to the information processing apparatus 20 from an external source. The input apparatus 24 may include an operating apparatus (e.g., a keyboard, a mouse, a touch panel, etc.) that is operable by an operator of the information processing apparatus 20. The input apparatus 24 may include a recording medium reading apparatus that is configured to read information recorded on a recording medium that is attachable to or detachable from the information processing apparatus 20, such as, for example, a USB (Universal Serial Bus) memory. In a case where information is inputted to the information processing apparatus 20 via the communication apparatus 23 (in other words, in a case where the information processing apparatus 20 acquires information via the communication apparatus 23), the communication apparatus 23 may function as an input apparatus.

The output apparatus 25 is an apparatus that is configured to output information to the outside of the information processing apparatus 20. The output apparatus 25 may output visual information such as characters and images, may output auditory information such as voice, or may output tactile information such as vibration, as the aforementioned information. The output apparatus 25 may include, for example, at least one of a display, a speaker, a printer, and a vibration motor. The output apparatus 25 may be configured to output information to a recording medium that is attachable to or detachable from the information processing apparatus 20, such as, for example, a USB memory. In a case where the information processing apparatus 20 outputs information via the communication apparatus 23, the communication apparatus 23 may function as an output apparatus.

The arithmetic apparatus 21 may include an image acquisition unit 211, a tracking unit 212, a facial recognition unit 213, a determination unit 214, and a notification unit 215, as function blocks realized logically or as processing circuits realized physically.

At least one of the image acquisition unit 211, the tracking unit 212, the facial recognition unit 213, the determination unit 214, and the notification unit 215 may be realized in a form in which logical function blocks and physical processing circuits (i.e., hardware) are mixed. In a case where at least a part of the image acquisition unit 211, the tracking unit 212, the facial recognition unit 213, the determination unit 214, and the notification unit 215 is a function block, the at least a part of the image acquisition unit 211, the tracking unit 212, the facial recognition unit 213, the determination unit 214, and the notification unit 215 may be realized by the arithmetic apparatus 21 executing a predetermined computer program.

The arithmetic apparatus 21 may acquire (in other words, read) the predetermined computer program from the storage apparatus 22. The arithmetic apparatus 21 may also read the predetermined computer program stored on a computer-readable, non-transitory recording medium, by using a not-illustrated recording medium reading apparatus provided in the information processing apparatus 20. The arithmetic apparatus 21 may acquire (in other words, may download or read) the predetermined computer program from a not-illustrated apparatus external to the information processing apparatus 20 via the communication apparatus 23. As the recording medium that records therein the predetermined computer program to be executed by the arithmetic apparatus 21, at least one of an optical disk, a magnetic medium, a magneto-optical disk, a semiconductor memory, and any other medium configured to store a program may be used.

The “image acquisition unit 211,” the “facial recognition unit 213,” the “determination unit 214,” and the “facial information DB 26” are components corresponding to the “image acquisition unit 11,” the “facial recognition unit 12,” the “determination unit 13,” and the “facial information DB 14” described in the first example embodiment above, respectively.

### Operation of Information Processing Apparatus

The information processing apparatus 20 performs facial recognition on the authentication subjects (i.e., the users of a special train), based on images captured by the camera CAMI. The information processing apparatus 20 may perform the facial recognition on the authentication subjects while the authentication subjects are passing through the facial recognition area Ar1. That is, the information processing apparatus 20 may be an apparatus that allows walk-through facial recognition.

In a case where the apparatus that is capable of physically preventing the passage of the authentication subjects is not provided between the facial recognition area Ar1 and the entry restriction area RAI, a facial recognition method performed by the information processing apparatus 20 may be referred to as gate-less facial recognition.

The image acquisition unit 211 acquires an image(s) including the facial recognition area Ar1, which is captured by the camera CAMI. The tracking unit 212 performs tracking processing on one or more authentication subjects (i.e., users of the station A) passing through the facial recognition area Ar1, by using the image(s) acquired by the image acquisition unit 211. Furthermore, the facial recognition unit 213 performs facial recognition processing on one or more authentication subjects passing through the facial recognition area Ar1, by using the image(s)acquired by the image acquisition unit 211.

As a specific example of the tracking processing performed by the tracking unit 212, a case where the tracking unit 212 performs the tracking processing on a person P1, who is an authentication subject passing through the facial recognition area Ar1 will be described with reference to FIG. 9. Furthermore, as a specific example of the facial recognition processing performed by the facial recognition unit 213, a case where the facial recognition unit 213 performs the facial recognition processing on the person P1, who is an authentication subject.

Images IMG1, IMG2, and IMG3 illustrated in FIG. 9 are images including the person P1 corresponding to the aforementioned authentication subject (in other words, images in which the person P1 is captured). Th image IMG1 is an image generated by the camera CAMI capturing the facial recognition area Ar1 at a time t1. The image IMG2 is an image generated by the camera CAMI capturing the facial recognition area Ar1 at a time t2, which is later than the time t1. The image IMG3 is an image generated by the camera CAMI capturing the facial recognition area Ar1 at a time t3, which is later than the time t2.

Each of the images IMG1, IMG2, and IMG3 may correspond to a single frame of a video. In this case, the image IMG2 may not correspond to a frame immediately after a frame corresponding to the image IMG1. That is, the image IMG2 may correspond to a frame that is two or more frames later than the frame corresponding to the image IMG1. Similarly, the image IMG3 may not correspond to a frame immediately after the frame corresponding to the image IMG2. That is, the image IMG3 may correspond to a frame that is two or more frames later than the frame corresponding to the image IMG2.

The tracking unit 212 detects, from the image IMG1, a head of the person P1 included in the image IMG1. Since existing techniques/technologies are applicable to a method of detecting a human head from an image, a detailed description of the method is omitted. Based on the detected head of the person P1, the tracking unit 212 sets an area including the head of the person P1 as a tracking area TA1.

In a case where the tracking area TA1 is set, the tracking unit 212 sets or assigns a tracking ID, which is identification information for identifying the person PI related to the tracking area TA1, to the person P1. The tracking unit 212 calculates a position of the person P1 (e.g., a position at the feet of the person P1) based on the tracking area TAI. Since existing techniques/technologies are applicable to a method of calculating, from an image, the position of a subject included in the image, a detailed description of the method is omitted. The tracking unit 212 links the tracking ID with the position of the person P1 and registers it in an ID correspondence table 221 stored in the storage apparatus 22.

In a case where the tracking area TAI is set, the tracking unit 212 determines whether or not a face of the person PI is captured in the tracking area TA1. In other words, the tracking unit 212 performs face detection on the tracking area TA1. In a case where it is determined that the face of the person P1 is captured in the tracking area TA1, the tracking unit 212 generates a facial image including a face area of the person P1. The tracking unit 212 links the generated facial image with the tracking ID of the person P1 and transmits it to the facial recognition unit 213. In a case where it is determined that the face of the person P1 is not captured in the tracking area TA1, the tracking unit 212 may not generate a facial image.

The facial recognition unit 213 performs the facial recognition processing by using the facial image transmitted from the tracking unit 212. For example, the facial recognition unit 213 may calculate facial feature quantities indicating the features of the face of the person P1 from the aforementioned facial image. The facial recognition unit 213 may calculate a matching score from the calculated facial feature quantities and from facial feature quantities based on the facial information on a single registrant stored in the facial information DB 26.

In a case where the calculated matching score is greater than a predetermined threshold, the facial recognition unit 213 determines that the facial recognition is successful. In this case, a single registrant corresponding to a person (here, the person P1) indicated by the facial image transmitted from the tracking unit 212 is identified from among a plurality of registrants registered in the facial information DB 26. On the other hand, in a case where the calculated matching score is less than the predetermined threshold, the facial recognition unit 213 determines that the facial recognition is failed. In this case, it is highly likely that a person corresponding to the person (here, the person P1) indicated by the facial image transmitted from the tracking unit 212 is not registered in the facial information DB 26. In a case where the calculated matching score is “equal” to the predetermined threshold, it may be included in one of the cases.

In a case where the facial recognition is successful, the facial recognition unit 213 links the authentication ID indicating the registrant registered in the face information DB 26 corresponding to the person (here, the person P1) indicated by the facial image transmitted from the tracking unit 212, to the tracking ID linked to the facial image described above, and registers it in the ID correspondence table 221. In addition to the authentication ID, the facial recognition unit 213 may register an authentication time, which is a time at which the facial recognition processing is performed, in the ID correspondence table 221. In a case where the facial recognition is failed, the facial recognition unit 213 may link information indicating that there is no matching person (e.g., “N/A (Not Applicable)”) to the tracking ID linked to the facial image transmitted from the tracking unit 212, and may register it in the ID correspondence table 221.

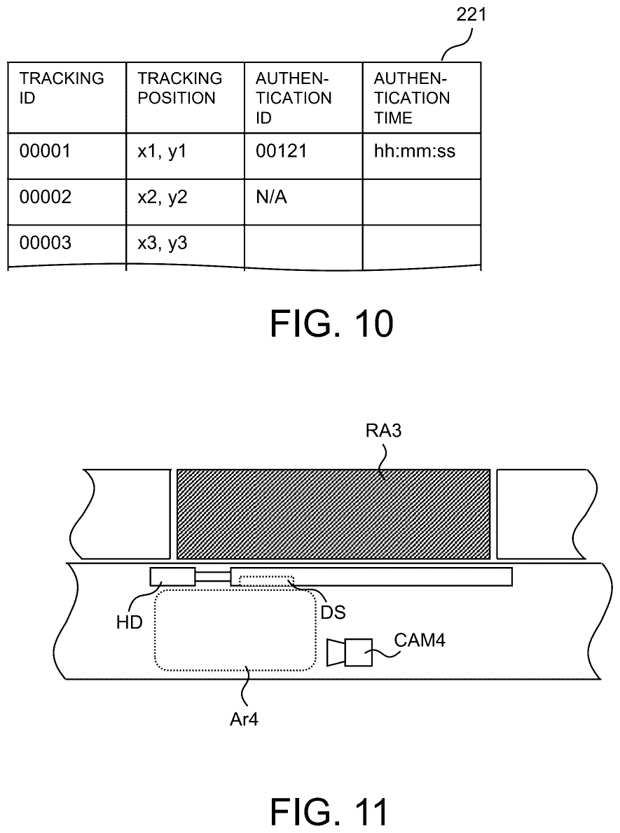

With reference to FIG. 10, the ID correspondence table 221 will be described. As illustrated in FIG. 10, the tracking ID, the tracking position (e.g., the position at the feet of the person P1), the authentication ID, and the authentication time are linked with each other in the ID correspondence table 221. In a case where the tracking ID is linked with a specific authentication ID in the ID correspondence table 221, it indicates that a registrant corresponding to a person for whom the tracking ID is set is registered in the facial information DB 26. In a case where the tracking ID is linked with the character string “N/A”, it indicates that a person corresponding to the person for whom the tracking ID is set is not registered in the facial information DB 26. In a case where the tracking ID is not linked with the authentication ID (i.e., in a case where a field of the authentication ID is blank), it indicates that the facial recognition processing has never been performed.

The tracking unit 212 may identify the person P1 included in the image IMG2, by using the image IMG2 and the image IMG1. Identifying the person P1 included in the image IMG2 is synonymous with establishing correspondence/mapping between the person P1 included in the image IMG1 and the person P1 included in the image IMG2. Therefore, at least one of a matching method and an optical flow method associated with the correspondence/mapping between images, is applicable to the identification of the person P1 included in the image IMG2. Since existing various aspects are applicable to each of the matching method and the optical flow method, a detailed description of each method is omitted.

In a case where the person P1 included in the image IMG2 is identified, the tracking unit 212 detects the head of the person P1. Based on the detected head of the person P1, the tracking unit 212 sets an area including the head of the person P1 as a tracking area TA2. Since the person P1 included in the image IMG1 and the person P1 included in the image IMG2 are the same person, the tracking ID of the person P1 related to the tracking area TA2 is the same as the tracking ID of the person PI related to the tracking area TA1. The tracking unit 212 calculates the position of the person P1 based on the tracking area TA2.

The tracking unit 212 links the position of the person P1 to the tracking ID of the person P1 and registers it in the ID correspondence table 221. In this case, since the position of the person P1 calculated based on the tracking area TA1 is registered in the ID correspondence table 221, the position of the person P1 is updated by the tracking unit 212 registering the position of the person P1 calculated based on the tracking area TA2, in the ID correspondence table 221.

In a case where the tracking area TA2 is set, the tracking unit 212 determines whether or not the face of the person P1 is captured in the tracking area TA2. In other words, the tracking unit 212 performs the face detection on the tracking area TA2. In a case where it is determined that the face of the person P1 is captured in the tracking area TA2, the tracking unit 212 generates a facial image including the face area of the person P1. The tracking unit 212 links the generated facial image with the tracking ID of the person P1 and transmits it to the facial recognition unit 213. In a case where it is determined that the face of the person P1 is not captured in the tracking area TA2, the tracking unit 212 may not generate a facial image. Even when it is determined that the face of the person P1 is captured in the tracking area TA2, in a case where the tracking ID of the person P1 is linked with the authentication ID in the ID correspondence table 221 (i.e., in a case where the facial recognition is already successful), the tracking unit 212 may not generate a facial image.

The facial recognition unit 213 performs the facial recognition processing by using the facial image transmitted from the tracking unit 212. In a case where the facial recognition is successful, the facial recognition unit 213 links the authentication ID indicating the registrant registered in the facial information DB 26 corresponding to the person (here, the person P1) indicated by the facial image transmitted from the tracking unit 212, to the tracking ID linked to the facial image described above, and registers it in the ID correspondence table 221. In addition to the authentication ID, the facial recognition unit 213 may register the authentication time, which is a time at which the facial recognition processing is performed, in the ID correspondence table 221. In a case where the authentication time is already registered in the ID correspondence table 221 (i.e., in a case where the facial recognition was successful in the past), the facial recognition unit 213 may update the authentication time registered in the ID correspondence table 221. In a case where the facial recognition is failed, the facial recognition unit 213 may link the information indicating that there is no matching person (e.g., “N/A”) to the tracking ID linked to the facial image transmitted from the tracking unit 212, and may register it in the ID correspondence table 221.

The tracking unit 212 may identify the person P1 included in the image IMG3 by using the image IMG3 and the image IMG2. In a case where the person P1 included in the image IMG3 is identified, the tracking unit 212 detects the head of the person P1. Based on the detected head of the person P1, the tracking unit 212 sets an area including the head of the person P1 as a tracking area TA3. Since the person P1 included in the image IMG2 and the person P1 included in the image IMG3 are the same person, the tracking ID of the person P1 related to the tracking area TA3 is the same as the tracking ID of the person P1 related to the tracking area TA2. The tracking unit 212 calculates the position of the person P1 based on the tracking area TA3.

The tracking unit 212 links the position of the person P1 to the tracking ID of the person P1 and registers it in the ID correspondence table 221. In this case, since the position of the person P1 calculated based on tracking area TA2 is registered in the ID correspondence table 221, the position of the person P1 is updated by the tracking unit 212 registering the position of the person P1 calculated based on tracking area TA3, in the ID correspondence table 221.

In a case where the tracking area TA3 is set, the tracking unit 212 determines whether or not the face of the person P1 is captured in the tracking area TA3. In other words, the tracking unit 212 performs the face detection on the tracking area TA3. In a case where it is determined that the face of the person P1 is captured in the tracking area TA3, the tracking unit 212 generates a facial image including the face area of the person P1. The tracking unit 212 links the generated facial image with the tracking ID of the person P1 and transmits it to the facial recognition unit 213. In a case where it is determined that the face of the person P1 is not captured in the tracking area TA3, the tracking unit 212 may not generate a facial image. Even when it is determined that the face of the person P1 is captured in the tracking area TA3, in a case where the tracking ID of the person P1 is linked with the authentication ID in the ID correspondence table 221 (i.e., in a case where the facial recognition is already successful), the tracking unit 212 may not generate a facial image.

The facial recognition unit 213 performs the facial recognition processing by using the facial image transmitted from the tracking unit 212. In a case where the facial recognition is successful, the facial recognition unit 213 links the authentication ID indicating the registrant registered in the facial information DB 26 corresponding to the person (here, the person P1) indicated by the facial image transmitted from the tracking unit 212, to the tracking ID linked to the facial image described above, and registers it in the ID correspondence table 221. In addition to the authentication ID, the facial recognition unit 213 may register the authentication time, which is a time at which the facial recognition processing is performed, in the ID correspondence table 221. In a case where the authentication time is already registered in the ID correspondence table 221 (i.e., in a case where the facial recognition was successful in the past), the facial recognition unit 213 may update the authentication time registered in the ID correspondence table 221. In a case where the facial recognition is failed, the facial recognition unit 213 may link the information indicating that there is no matching person (e.g., “N/A”) to the tracking ID linked to the facial image transmitted from the tracking unit 212, and may register it in the ID correspondence table 221.

By the way, it may be difficult for the tracking unit 212 to continue tracking the person P1 due to the head of the person P1 being hidden by another person, for example. In a case where the tracking of the person P1 is interrupted, the tracking unit 212 may perform the following processing. After the tracking of the person PI is interrupted, the tracking unit 212 may determine whether or not a new person is detected from the image acquired by the image acquisition unit 211 (e.g., the image captured by the camera CAMI). The “new person” means a person for whom the tracking ID is not set.

In a case where a new person is detected, the tracking unit 212 may determine whether or not the person P1 and the new person are the same person by comparing the feature quantities of the tracking area related to the person PI (e.g., at least one of the tracking areas TA1, TA2, and TA3) with the feature quantities of the tracking area related to the new person. In a case where it is determined that the person P1 and the new person are the same person, the tracking unit 212 may set the tracking ID of the person P1 for the new person. As a result, the tracking unit 212 is allowed to track the person P1 again.

The feature quantities may be feature quantities related to the head of a person, feature quantities related to an upper body of the person, or feature quantities related to an entire body of the person. That is, the tracking area (e.g., at least one of the tracking areas TA1, TA2, and TA3) may include the head of the person, the upper body of the person, or the entire body of the person. The feature quantities may be obtained, for example, by using a Person Re-Identification technology.

The tracking unit 212 and the facial recognition unit 213 may repeat the aforementioned processing until the person P1 passes through the facial recognition area Ar1. The tracking unit 212 and the facial recognition unit 213 may perform the aforementioned processing on all the authentication subjects passing through the facial recognition area Ar1.

The determination unit 214 acquires the ticket issuance information linked to the authentication ID of the registrant corresponding to the authentication subject (e.g., the person P1) identified by the facial recognition unit 213 performing the facial recognition, based on the ID correspondence table 221 and the facial information DB 26. In a case where the ticket issuance information is not linked to the authentication ID (i.e., the registrant associated with the authentication ID does not purchase a limited express train ticket), the determination unit 214 may acquire, for example, information indicating that “the authentication subject does not have a valid limited express train ticket” as the ticket issuance information.

The determination unit 214 determines, based on the acquired ticket issuance information, whether or not the authentication subject (in other words, the registrant identified by the facial recognition unit 213) is permitted to enter the entry restriction area RA1.

For example, in a case where the ticket issuance information indicates information about a valid limited express train ticket, the determination unit 214 may determine that the aforementioned authentication subject is permitted to enter the entry restriction area RA1. For example, in a case where the ticket issuance information indicates information about an invalid limited express train ticket, the determination unit 214 may determine that the aforementioned authentication subject is not permitted to enter the entry restriction area RA1.

The notification unit 215 generates notification information based on a determination result of the determination unit 214. In a case where the determination result of the determination unit 214 indicates that “the authentication subject is permitted to enter the entry restriction area RA1,” the notification unit 215 may generate, for example, notification information indicating that “entry is permitted.” For example, a digital signage serving as the output apparatus 25 may be disposed near the entry restriction area RA1. The digital signage may be disposed at a position that does not obstruct the passage of the users of a special train (e.g., one of a position higher than the users' heads and a floor). In this case, the notification unit 215 may transmit the notification information indicating that “entry is permitted” to the output apparatus 25. As a result, for example, at least one of text, graphics, and images indicating that entry is permitted, may be displayed on the digital signage.

In a case where the determination result of the determination unit 214 indicates that “the authentication subject is not permitted to enter the entry restriction area RA1,” the notification unit 215 may generate, for example, notification information indicating that “entry is not permitted.” In this case, the notification unit 215 may transmit the notification information indicating that “entry is not permitted” to the output apparatus 25. As a result, for example, at least one of text, graphics, and images indicating that entry is not permitted, may be displayed on the digital signage. In this case, an audible warning may also be emitted in addition to the display.

Furthermore, the ticket issuance information registered in the facial information DBs 26 and 70 may include information about a valid limited express train ticket (i.e., a limited express train ticket within its valid usage period), information about an invalid limited express train ticket (i.e., a ticket outside its valid usage period), and information indicating that the authentication subject does not have a limited express train ticket. In a case where the determination unit 214 determines that the authentication subject is not permitted to enter the entry restriction area RA1, the determination unit 214 may output a reason why the authentication subject is not permitted to enter (in other words, entry is not permitted).

For example, in a case where the ticket issuance information indicates the information about an invalid limited express train ticket, the determination unit 214 may determine that the authentication subject is not permitted to enter the entry restriction area RAI, and may output information indicating “outside the valid usage period.” The notification unit 215 may generate, for example, notification information indicating that “entry is not permitted” and “reason: outside the valid usage period.” In this case, the notification unit 215 may transmit the notification information indicating that “entry is not permitted” and “reason: outside the valid usage period”, to the output apparatus 25. As a result, for example, at least one of text, graphics, and images indicating that entry is not permitted, and a message such as “Please notify the station staff”, may be displayed on the digital signage.

For example, in a case where the ticket issuance information indicates that the authentication subject does not have a limited express train ticket, the determination unit 214 may determine that the authentication subject is not permitted to enter the entry restriction area RA1, and may output information indicating that “the authentication subject does not have a limited express train ticket.” The notification unit 215 may generate, for example, notification information indicating that “entry is not permitted” and “reason: no limited express train ticket”. In this case, the notification unit 215 may transmit the notification information indicating that “entry is not permitted” and “reason: no limited express train ticket”, to the output apparatus 25. As a result, for example, at least one of text, graphics, and images indicating that entry is not permitted, and a message such as “You need to purchase a limited express train ticket to enter”, may be displayed on the digital signage.

### Technical Effect

According to the information processing apparatus 20, as in the information processing apparatus 10 described above, it is possible to appropriately collect the special fee from the users of a special train.

### Third Example Embodiment

An information processing apparatus, an information processing method, and a recording medium according to a third example embodiment will be described with reference to FIG. 11. The following describes the information processing apparatus, the information processing method, and the recording medium according to the third example embodiment, by using an information processing apparatus 20. In the third example embodiment, a description that overlaps with that of the second example embodiment is omitted as appropriate.

In the third example embodiment, the ticket gate system 1 illustrated in FIG. 1 may include, for example, the information processing apparatus 20 installed at the station A. Note that an information processing apparatus similar to the information processing apparatus 20 may also be installed at the station B, for example.

Let us assume that a local train with a special car attached (i.e., a train in which a part of cars in a train formation is a special car(s), and the remaining cars are ordinary cars that may be boarded by paying a basic fare only) stops at the station A. On the platform at the station A, as illustrated in FIG. 11, a platform door HD is installed in a part corresponding to a stopping position of the special car. The platform door HD is provided with a digital signage DS serving as the output apparatus 25 of the information processing apparatus 20. Note that a platform door may also be installed in a part other than the stopping position of the special car on the platform at the station A.

Let us assume that only users holding limited express train tickets may board the special car. Therefore, the special car may be referred to as an entry restriction area. In FIG. 11, a hatched area is an entry restriction area RA3 corresponding to the special car.

A facial recognition area Ar4 for the users (in other words, passengers) of the special car to pass through is set before the entry restriction area RA3 (here, on the platform). The facial recognition area Ar4 is a virtual area. Therefore, for example, any markings or the like indicating the facial recognition area Ar4 may not be drawn on the platform. However, markings or the like indicating the facial recognition area Ar4 may be drawn on the platform.

A camera CAM4 is installed to capture images of the facial recognition area Ar4. The camera CAM4 may not be installed such that the entire facial recognition area Ar4 is included within its angle of view. In other words, the camera CAM4 may be installed to capture images of at least a part of the facial recognition area Ar4. The camera CAM4 may be installed at a position that does not obstruct the passage of the users of the special car (e.g., at a position higher than the users' heads).

The image acquisition unit 11 of the information processing apparatus 20 acquires an image including the facial recognition area Ar4 captured by the camera CAM4. The tracking unit 212 performs the tracking processing on one or more authentication subjects (i.e., the users of the station A) passing through the facial recognition area Ar4, by using the image acquired by the image acquisition unit 211. Furthermore, the facial recognition unit 213 performs the facial recognition processing on one or more authentication subjects passing through the facial recognition area Ar4, by using the image acquired by the image acquisition unit 211.

The determination unit 214 acquires the ticket issuance information linked to the authentication ID of the registrant corresponding to the authentication subject identified by the facial recognition unit 213 performing the facial recognition, based on the ID correspondence table 221 and the facial information DB 26.

The determination unit 214 may determine whether or not the authentication subject (in other words, the registrant identified by the facial recognition unit 213) is permitted to enter the entry restriction area RA3 (in other words, whether or not the authentication subject is permitted to board the special car), based on the acquired ticket issuance information and operation information about the special car.

For example, in a case where the ticket issuance information indicates information about a valid limited express train ticket, and in a case where the special car that may be boarded with the limited express train ticket is stopped at the station A or arrives at the station A before a local train with another special car attached, the determination unit 214 may determine that the aforementioned authentication subject is permitted to enter the entry restriction area RA3.

For example, in a case where the ticket issuance information indicates the information about a valid limited express train ticket, but in a case where the special car that may be boarded with the limited express train ticket arrives at the station A after a local train with another special car attached, the determination unit 214 may determine that the aforementioned authentication subject is not permitted to enter the entry restriction area RA3. For example, in a case where the ticket issuance information indicates information about an invalid limited express train ticket, the determination unit 214 may determine that the aforementioned authentication subject is not permitted to enter the entry restriction area RA3.

The notification unit 215 may generate the notification information based on the determination result of the determination unit 214. In a case where the determination result of the determination unit 214 indicates that “the authentication subject is permitted to enter the entry restriction area RA3,” the notification unit 215 may generate, for example, notification information indicating that “entry is permitted.” In this case, the notification unit 215 may transmit the notification information indicating that “entry is permitted” to the output apparatus 25. As a result, for example, at least one of text, graphics, and images indicating that entry is permitted, may be displayed on the digital signage DS.

In a case where the determination result of the determination unit 214 indicates that “the authentication subject is not permitted to enter the entry restriction area RA3,” the notification unit 215 may generate, for example, notification information indicating that “entry is not permitted.” In this case, the notification unit 215 may transmit the notification information indicating that “entry is not permitted” to the output apparatus 25. As a result, for example, at least one of text, graphics, and images indicating that entry is not permitted, may be displayed on the digital signage DS. In this case, an audible warning may also be emitted in addition to the display.

Furthermore, the ticket issuance information registered in the facial information DBs 26 and 70 may include information about a valid limited express train ticket (i.e., a limited express train ticket within its valid usage period), information about an invalid limited express train ticket (i.e., a ticket outside its valid usage period), and information indicating that the authentication subject does not have a limited express train ticket. In a case where the determination unit 214 determines that the authentication subject is not permitted to enter the entry restriction area RA3, the determination unit 214 may output a reason why the authentication subject is not permitted to enter (in other words, entry is not permitted).

For example, in a case where the ticket issuance information indicates the information about an invalid limited express train ticket and specifically indicates information about a limited express train ticket before its valid usage period, the determination unit 214 may determine that the authentication subject is not permitted to enter the entry restriction area RA3, and may output information indicating “before the valid usage period”. The notification unit 215 may generate, for example, notification information indicating that “entry is not permitted” and “reason: before the valid usage period”. In this case, the notification unit 215 may transmit the notification information indicating that “entry is not permitted” and “reason: before the valid usage period”, to the output apparatus 25. As a result, for example, at least one of text, graphics, and images indicating that entry is not permitted, and a message such as “This is not the train you are boarding”, may be displayed on the digital signage DS.

For example, in a case where the ticket issuance information indicates the information about an invalid limited express train ticket and specifically indicates information about a limited express train ticket after a lapse of its valid usage period, the determination unit 214 may determine that the authentication subject is not permitted to enter the entry restriction area RA3, and may output information indicating “after a lapse of the valid usage period”. The notification unit 215 may generate, for example, notification information that “entry is not permitted” and “reason: after a lapse of the valid usage period.” In this case, the notification unit 215 may transmit the notification information that “entry is not permitted” and “reason: after a lapse of the valid usage period”, to the output apparatus 25. As a result, for example, at least one of text, graphics, and images indicating that entry is not permitted, and a message such as “Please notify the station staff”, may be displayed on the digital signage DS.

For example, in a case where the ticket issuance information indicates that the authentication subject does not have a limited express train ticket, the determination unit 214 may determine that the authentication subject is not permitted to enter the entry restriction area RA3, and may output information indicating that “the authentication subject does not have a limited express train ticket.” The notification unit 215 may generate, for example, notification information indicating that “entry is not permitted” and “reason: no limited express train ticket.” In this case, the notification unit 215 may transmit the notification information indicating that “entry is not permitted” and “reason: no limited express train ticket”, to the output apparatus 25. As a result, for example, at least one of text, graphics, and images indicating that entry is not permitted, and a message such as “You need to purchase a limited express train ticket for boarding”, may be displayed on the digital signage DS.

### Technical Effect

According to the information processing apparatus 20 in the third example embodiment, as in the information processing apparatus 20 in the second example embodiment described above, it is possible to appropriately collect the special fee from the users of the special car.

### Modified Example

On the platform of a station (e.g., the station A) where a local train with two or more special cars attached stops, a plurality of facial recognition areas corresponding to respective stopping positions of the two or more special cars may be set.

The determination unit 214 acquires the ticket issuance information linked to the authentication ID of the registrant corresponding to the authentication subject identified by the facial recognition unit 213 performing the facial recognition, based on the ID correspondence table 221 and the facial information DB 26. The determination unit 214 acquires information indicating the position of the authentication subject (e.g., “tracking position” in FIG. 10) based on the ID correspondence table 221.

The determination unit 214 may determine whether or not the authentication subject (i.e., the registrant identified by the facial recognition unit 213) is permitted to enter the entry restriction area (e.g., the entry restriction area RA3) (in other words, whether or not the authentication subject is permitted to board the special car), based on the acquired ticket issuance information, the acquired information indicating the position of the authentication subject, and the operation information on the special car.

For example, in a case where (i) the ticket issuance information indicates information about a valid limited express train ticket, and (ii) the special car that may be boarded with the limited express train ticket is stopped at the station A or arrives at the station A before a local train with another special car attached, and (iii) the position of the authentication subject is in the vicinity of a boarding position for the special car that may be boarded with the limited express train ticket, the determination unit 214 may determine that the aforementioned authentication subject is permitted to enter the entry restriction area.

For example, in a case where (i) the ticket issuance information indicates the information about a valid limited express train ticket, and (ii) the special car that may be boarded with the limited express train ticket is stopped at the station A or arrives at the station A before a local train with another special car attached, and (iii) the position of the authentication subject is away from the boarding position for the special car a that may be boarded with the limited express train ticket (e.g., the authentication subject is at a wrong boarding position), the determination unit 214 may determine that the authentication subject is permitted to enter the entry restriction area, but is at

For example, in a case where the ticket issuance information indicates the information about a valid limited express train ticket, but the special car that may be boarded with the limited express train ticket arrives at the station A after a local train with another special car attached, the determination unit 214 may determine that the aforementioned authentication subject is not permitted to enter the entry restriction area. For example, in a case where the ticket issuance information indicates information about an invalid limited express train ticket, the determination unit 214 may determine that the aforementioned authentication subject is not permitted to enter the entry restriction area.

The notification unit 215 may generate the notification information based on the determination result of the determination unit 214. In a case where the determination result of the determination unit 214 indicates that “the authentication subject is permitted to enter the entry restriction area,” the notification unit 215 may generate, for example, notification information indicating that “entry is permitted.” In this case, the notification unit 215 may transmit the notification information indicating that “entry is permitted” to the output apparatus 25. As a result, for example, at least one of text, graphics, and images indicating that entry is permitted, may be displayed on the digital signage (e.g., the digital signage DS).

In a case where the determination result of the determination unit 214 indicates that “the authentication subject is not permitted to enter the entry restriction area,” the notification unit 215 may generate, for example, notification information indicating that “entry is not permitted.” In this case, the notification unit 215 may transmit the notification information indicating that “entry is not permitted” to the output apparatus 25. As a result, for example, at least one of text, graphics, and images indicating that entry is not permitted, may be displayed on the digital signage (e.g., the digital signage DS). In this case, an audible warning may also be emitted in addition to the display.

Furthermore, the ticket issuance information registered in the facial information DBs 26 and 70 may include information about a valid limited express train ticket (i.e., a limited express train ticket within its valid usage period), information about an invalid limited express train ticket (i.e., a ticket outside its valid usage period), and information indicating that the authentication subject does not have a limited express train ticket. In a case where the determination unit 214 determines that the authentication subject is not permitted to enter the entry restriction area (e.g. the entry restriction area RA3), the determination unit 214 may output a reason why the authentication subject is not permitted to enter (in other words, entry is not permitted).

For example, in a case where the ticket issuance information indicates the information about an invalid limited express train ticket and specifically indicates information about a limited express train ticket before its valid usage period, the determination unit 214 may determine that the authentication subject is not permitted to enter the entry restriction area (e.g. the entry restriction area RA3), and may output information indicating “before the valid usage period”. The notification unit 215 may generate, for example, notification information indicating that “entry is not permitted” and “reason: before the valid usage period”. In this case, the notification unit 215 may transmit the notification information indicating that “entry is not permitted” and “reason: before the valid usage period”, to the output apparatus 25. As a result, for example, at least one of text, graphics, and images indicating that entry is not permitted, and a message such as “This is not the train you are boarding”, may be displayed on the digital signage (e.g. the digital signage DS).

For example, in a case where the ticket issuance information indicates the information about an invalid limited express train ticket and specifically indicates information about a limited express train ticket after a lapse of its valid usage period, the determination unit 214 may determine that the authentication subject is not permitted to enter the entry restriction area (e.g. the entry restriction area RA3), and may output information indicating “after a lapse of the valid usage period”. The notification unit 215 may generate, for example, notification information that “entry is not permitted” and “reason: after a lapse of the valid usage period.” In this case, the notification unit 215 may transmit the notification information that “entry is not permitted” and “reason: after a lapse of the valid usage period”, to the output apparatus 25. As a result, for example, at least one of text, graphics, and images indicating that entry is not permitted, and a message such as “Please notify the station staff”, may be displayed on the digital signage (e.g. the digital signage DS).

For example, in a case where the ticket issuance information indicates that the authentication subject does not have a limited express train ticket, the determination unit 214 may determine that the authentication subject is not permitted to enter the entry restriction area (e.g. the entry restriction area RA3), and may output information indicating that “the authentication subject does not have a limited express train ticket.” The notification unit 215 may generate, for example, notification information indicating that “entry is not permitted” and “reason: no limited express train ticket.” In this case, the notification unit 215 may transmit the notification information indicating that “entry is not permitted” and “reason: no limited express train ticket”, to the output apparatus 25. As a result, for example, at least one of text, graphics, and images indicating that entry is not permitted, and a message such as “You need to purchase a limited express train ticket for boarding”, may be displayed on the digital signage (e.g. the digital signage DS).

In a case where the determination result of the determination unit 214 indicates that “the authentication subject is permitted to enter the restricted area, but is at the wrong boarding position,” the notification unit 215 may change notification content, based on the current time and an arrival time of the special car.

For example, in a case where a difference between the current time and the arrival time is shorter than a predetermined time, the notification unit 215 may generate, for example, notification information indicating that “entry is permitted” and “moving to a car X.” In this case, the notification unit 215 may transmit the notification information indicating that “entry is permitted” and “moving to a car X”, to the output apparatus 25. As a result, for example, at least one of text, graphics, and images indicating that entry is permitted, and a message such as “Please move to the car X after boarding”, may be display on the digital signage (e.g., the digital signage DS).

For example, in a case where the difference between the current time and the arrival time is longer than the predetermined time, the notification unit 215 may generate, for example, notification information indicating that “entry is not permitted” and “moving to a car X”. In this case, the notification unit 215 may transmit the notification information indicating that “entry is not permitted” and “moving to a car X”, to the output apparatus 25. As a result, for example, at least one of text, graphics, and images indicating that entry is not permitted, and a message such as “Please move to the boarding position for the car X”, may be display on the digital signage (e.g., the digital signage DS).

### SUPPLEMENTARY NOTES

With respect to the example embodiment described above, the following Supplementary Notes are further disclosed.

### Supplementary Note 1

An information processing apparatus including:
an image acquisition unit that acquires an image including a facial recognition area, which is set before an entry restriction area in which a user of a special car requiring a special fee is permitted to enter, and through which the user passes;
a facial recognition unit that performs facial recognition on an authentication subject who is the user, based on the image; and
a determination unit that acquires ticket information about a ticket for the special car linked to a registrant corresponding to the authentication subject, who is identified by the facial recognition, and that determines whether or not the authentication subject is permitted to enter the entry restriction area.

### Supplementary Note 2

The information processing apparatus according to Supplementary Note 1, wherein
the information processing apparatus includes a tracking unit that tracks the authentication subject based on the image, and
the facial recognition unit performs facial recognition on the authentication subject, while the tracking unit is tracking the authentication subject.

### Supplementary Note 3

The information processing apparatus according to Supplementary Note 1 or 2, wherein the determination unit determines whether or not the authentication subject is permitted to enter the entry restriction area, based on operation information on the special car, in addition to the ticket information.

### Supplementary Note 4

The information processing apparatus according to any one of Supplementary Notes 1 to 3, wherein the facial recognition area is set in at least a part of a passageway leading to the entry restriction area.

### Supplementary Note 5

The information processing apparatus according to any one of Supplementary Notes 1 to 4, wherein an end of the facial recognition area on a side of the entry restriction area is set to be in contact with a part of an outer edge of the entry restriction area.

### Supplementary Note 6

The information processing apparatus according to any one of Supplementary Notes 1 to 4, wherein a platform door is installed between the facial recognition area and the entry restriction area.

### Supplementary Note 7

The information processing apparatus according to any one of Supplementary Notes 1 to 6, wherein the information processing apparatus includes a notification unit that generates notification information, based on a determination result of the determination unit.

### Supplementary Note 8

An information processing method including:
acquiring an image including a facial recognition area, which is set before an entry restriction area in which a user of a special car requiring a special fee is permitted to enter, and through which the user passes;

performing facial recognition on an authentication subject, based on the image; and
acquiring ticket information about a ticket for the special car linked to a registrant corresponding to the authentication subject, who is identified by the facial recognition, and determining whether or not the authentication subject is permitted to enter the entry restriction area.

### Supplementary Note 9

A recording medium on which a computer program that allows a computer to execute an information processing method is recorded, the information processing method including:
acquiring an image including a facial recognition area, which is set before an entry restriction area in which a user of a special car requiring a special fee is permitted to enter, and through which the user passes;
performing facial recognition on an authentication subject, based on the image; and
acquiring ticket information about a ticket for the special car linked to a registrant corresponding to the authentication subject, who is identified by the facial recognition, and determining whether or not the authentication subject is permitted to enter the entry restriction area.

The present disclosure is permitted to be changed, if desired, without departing from the essence or spirit of this disclosure which can be read from the claims and the entire specification. An information processing apparatus, an information processing method, and a recording medium with such changes are also intended to be within the technical scope of the present disclosure.

### DESCRIPTION OF REFERENCE CODES

1 Ticket gate system
10, 20 Information processing apparatus
11, 211 Image acquisition unit
12, 213 Facial recognition unit
13, 214 Determination unit
14, 26, 70 Facial information database
212 Tracking unit
215 Notification unit

What is claimed is:

1. An information processing apparatus comprising:
at least one memory configured to store instructions; and
at least one processor configured to execute the instructions to:
acquire an image including a facial recognition area, which is set before an entry restriction area in which a user of a special car requiring a special fee is permitted to enter, and through which the user passes;
perform facial recognition on an authentication subject who is the user, based on the image;
acquire ticket information about a ticket for the special car linked to a registrant corresponding to the authentication subject, who is identified by the facial recognition, position information of the authentication subject linked to the registrant corresponding to the authentication subject, and operation information on the special car; and
determine whether or not the authentication subject is permitted to enter the entry restriction area, based on the ticket information, the position information of the authentication subject and the operation information.

2. The information processing apparatus according to claim 1, wherein the at least one processor is configured to execute the instructions to:
track the authentication subject based on the image, and
perform facial recognition on the authentication subject, while tracking unit is tracking the authentication subject.

3. (canceled)

4. The information processing apparatus according to claim 1, wherein the facial recognition area is set in at least a part of a passageway leading to the entry restriction area.

5. The information processing apparatus according to claim 1, wherein an end of the facial recognition area on a side of the entry restriction area is set to be in contact with a part of an outer edge of the entry restriction area.

6. The information processing apparatus according to claim 1, wherein a platform door is installed between the facial recognition area and the entry restriction area.

7. The information processing apparatus according to any claim 1, wherein the at least one processor is configured to execute the instructions to generate notification information, based on a determination result.

8. An information processing method comprising:
acquiring an image including a facial recognition area, which is set before an entry restriction area in which a user of a special car requiring a special fee is permitted to enter, and through which the user passes;
performing facial recognition on an authentication subject, based on the image;
acquiring ticket information about a ticket for the special car linked to a registrant corresponding to the authentication subject, who is identified by the facial recognition, position information of the authentication subject linked to the registrant corresponding to the authentication subject, and operation information on the special car; and
determining whether or not the authentication subject is permitted to enter the entry restriction area, based on the ticket information, the position information of the authentication subject and the operation information.

9. A non-transitory recording medium on which a computer program that allows a computer to execute an information processing method is recorded, the information processing method including:
acquiring an image including a facial recognition area, which is set before an entry restriction area in which a user of a special car requiring a special fee is permitted to enter, and through which the user passes;
performing facial recognition on an authentication subject, based on the image; and
acquiring ticket information about a ticket for the special car linked to a registrant corresponding to the authentication subject, who is identified by the facial recognition, position information of the authentication subject linked to the registrant corresponding to the authentication subject, and operation information on the special car; and
determining whether or not the authentication subject is permitted to enter the entry restriction area, based on the ticket information, the position information of the authentication subject and the operation information.
